(19) United States
(12) Patent Application Publication
(10) Pub. No.: US 2024/0064418 A1
(43) Pub. Date: Feb. 22, 2024

(54) AUTONOMOUS ROTATING SENSOR DEVICE AND CORRESPONDING DATA PROCESSING OPTIMIZATION METHOD

(71) Applicant: LG INNOTEK CO., LTD., Seoul (KR)

(72) Inventors: Joshua S. Smith, Livonia, ML (US); Esther Wei, Monroe Township, NJ (US); Samuel Richard WILTON, Levittown, PA (US)

(73) Assignee: LG INNOTEK CO., LTD., Seoul (KR)

(21) Appl. No.: 18/322,264

(22) Filed: May 23, 2023

Related U.S. Application Data
(60) Provisional application No. 63/398,923, filed on Aug. 18, 2022.
(60) Provisional application No. 63/402,385, filed on Aug. 30, 2022.

(51) Int. Cl. H04N 23/81; G01S 7/481; G01S 7/497; H04N 23/60

(52) U.S. Cl. CPC H04N 23/81; G01S 7/4817; G01S 7/497; H04N 23/60

(57) ABSTRACT

A method of controlling a rotational imaging device, and which includes capturing imaging data from a sensor in the imaging device; and controlling a rotational movement of the rotational imaging device to be synchronized with the capturing of the image data via a same system clock.

### CROSS REFERENCE TO RELATED APPLICATIONS

This application claims the benefit under 35 U.S.C. § 119(e) to U.S. Provisional Application No. 63/398,923, filed on Aug. 18, 2022, and 63/402,385, filed on Aug. 30, 2022, all of which are hereby expressly incorporated by reference into the present application.

### BACKGROUND OF THE INVENTION

### 1. Field of the Invention

The present disclosure relates to an autonomous rotating sensor device and corresponding method of controlling the autonomous rotating sensor device.

### 2. Background of the Invention

Autonomous vehicles AVs) use a plurality of sensors for situational awareness. The sensors, which are part of a self-driving system (SDS) in the AV, include one or more of a camera, lidar (Light Detection and Ranging) device, inertial measurement unit (IMU), etc. The sensors such as cameras and lidar are used to capture and analyze scenes around the AV. The captured scenes are then used to detect objects including static objects such as fixed constructions, and dynamic objects such as pedestrians and other vehicles. In addition, data collected from the sensors can also be used to detect conditions such as road markings, lane curvature, traffic lights and signs, etc. Further, a scene representation such as 3D point cloud obtained from the AVs lidar can be combined with one or more images from the cameras to obtain further insight to the scene or situation around the AV.

Further, the lidar transceiver can include one or more photodetectorse that converts incident light or other electromagnetic radiation in the ultraviolet (UV), visible, and infrared spectral regions into electrical signals. Photodetectors can be used in a wide array of applications including, for example, fiber optic communication systems, process controls, environmental sensing, safety and security, and other imaging applications such as light detection and ranging applications. High photodetector sensitivity allows for detection of faint signals returned from distant objects. However, such sensitivity to optical signals requires a high degree of alignment between its components and alignment in the emission of the lasers.

### SUMMARY OF THE INVENTION

Accordingly, an object of the present invention is to provide an autonomous vehicle sensor using optimization to increase the performance without reducing the data quality.

In another aspect, the present disclosure provides a method of acquiring an optical impression using a rotational imaging device, where the rotational movement of the rotational imaging device is coordinated with a system clock, such as a precision time protocol.

In yet another aspect, the present disclosure provides a method of acquiring an optical impression using a rotational imaging device, where a view angle of a sensor of the rotational imaging device is controlled with respect to an azimuthal angle, to maintain the azimuthal angle constant or near constant during acquisition.

In yet another aspect, the present disclosure provides an imaging device for acquiring optical impression via a rotational scan, where the rotational scan speed of the device and/or an angular position of the device are controlled such that a positional drift in the view-angle of the device is minimized.

In another aspect, the present disclosure provides a method of processing imaging data acquired via a rotational imaging device, which includes dividing the imaging data into two or more parts, and where the dividing into the parts is performed by grouping the data parts according to an angular position or range of scan at which the respective parts were acquired.

To achieve these and other advantages and in accordance with the purpose of the present invention, as embodied and broadly described herein, the present invention provides in one aspect a method of controlling a rotational imaging device, and which includes capturing imaging data from a sensor in the imaging device, and controlling a rotational movement of the rotational imaging device to be synchronized with the capturing of the image data via a same system clock.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will become more fully understood from the detailed description given hereinbelow and the accompanying drawings, which are given by illustration only, and thus are not limitative of the present invention, and wherein:

FIG. 1 is a flow chart illustrating a single super-pixel filtering method on a histogram data according to an embodiment of the present disclosure;

FIG. 2 is a flow chart illustrating phases of a histogrammer according to an embodiment of the present disclosure;

FIG. 3 is a block diagram illustrating an operation of a write histogram phase in a device according to an embodiment of the present disclosure;

FIG. 4 is a timing diagram illustrating histogram memory read and clear timings according to an embodiment of the present disclosure;

FIG. 5 is a diagram illustrating a DSP pipeline resource sharing the same resource according to an embodiment of the present disclosure; and

FIG. 6 is a timing diagram illustrating a sub-histogrammer output for a streaming interface according to an embodiment of the present disclosure.

### DETAILED DESCRIPTION OF THE INVENTION

Reference will now be made in detail to the preferred embodiments of the present invention, examples of which are illustrated in the accompanying drawings.

A sensor such as a lidar sensor operating on an AV includes a transceiver apparatus including a transmitter assembly and a receiver assembly. In such a lidar setup, the transmitter transmits a light signal and the receiver, including one or more photo detectors, receives and processes the received light signal.

In addition, a lidar can use a fixed pixel size (angular resolution) with a fixed quantity of raw data integrated per point. It is advantageous to use more intelligent data integration approaches which adapt to the characteristics of the target to improve detection probability and data quality (range and intensity accuracy and precision).

In a Geiger mode avalanche photodiode (GmAPD) lidar system, the sensor includes an avalanche detector (or photodiode) configured to produce an electrical pulse of a given amplitude in response to an absorption of a photon of the same or similar wavelength as the light signal which was emitted. A histogram is then assembled over many trials, and the location of an object's surface is estimated from the peak of the histogram. The term “trial” refers to each measurement attempt.

Further, a measurement attempt includes sending a pulse and recording the detection time. Also, the trial is associated with the measurement, but not always the pulse. There can also be multiple trials from a single pulse by grouping the detections from multiple detectors. Each detector output is also a measurement. However, the accuracy of the histogram is limited by the width of a bin.

In more detail, a digital signal processing (DSP) circuit/module/processor integrates the GmAPD lidar system data both spatially and temporally to generate lidar data. In particular, the raw GmAPD data is first transformed into histograms before being processed. In addition, to differentiate between a signal and noise, a histogram filter is applied to the histograms for statistically significant peaks. Once these peaks are identified, the high-resolution histogram data of the region containing the peaks is used to extract more information on any presumed targets. Due to the high GmAPD data rate and the FPGA resource constraints, real-time processing requires optimization. Accordingly, embodiments of the present disclosure include systems and using DSP optimization methodologies that increase performance without reducing the data quality.

In more detail, according to one embodiment of the present disclosure, a multi-stage histogramming method enables reconstruction of a portion of high-resolution histograms only at the temporal regions of interest. That is, as the raw GmAPD data is transformed into histograms, a copy of the raw data is buffered in an internal memory of Field-programmable gate array (FPGA). As each word of histogram data is read out by the filter module, the memory location where that histogram data resides is cleared and ready for the histogram generation of the next group of data. Further, once each peak of statistical significance is discovered by the filter, the stored raw data is used to reconstruct the sub-histograms at the global maxima positions and radial span of time defined by the local peak-search radius, with the highest-possible temporal resolution.

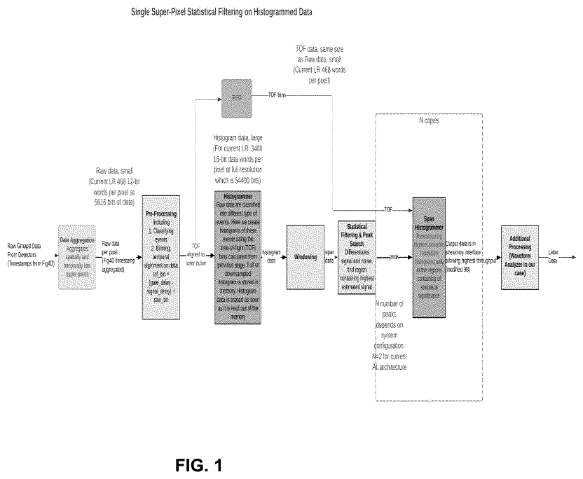

FIG. 1 is a flow chart illustrating a single super-pixel statistical filtering method on histogrammed data according to an embodiment of the present disclosure. That is, the described system and method according to embodiments of the present invention provide an optimized DSP solution that can utilize a smaller processor (e.g., smaller FPGA) that can further reduce cost and power consumption. The present disclosure describes a method of pipelining to improve area utilization, Fmax, and timing closure. The data quality is also improved. That is, efficient implementation of processing the data sensed by the AV sensor allows for higher resolution data to be processed and also provides an improved quantization of the data. processing leaves areas in the FPGA for additional processing, which can be removed for size considerations, or utilized for additional processing bandwidth.

One purpose of the detection pipeline is to generate target waveform data from raw sensor data. Also, to discriminate between signal and noise, the data is first transformed into histograms and then a filter is applied. As shown in FIG. 1, a histogrammer integrates time-of-flight data (ToF)data over multiple GmAPD frames to generate a histogram of avalanche events and a histogram of arming events.

As shown in FIG. 1, raw GmAPD data is first aggregated spatially and temporally into super-pixels. The raw data per pixel time-stamped is then fed to a pre-processor method of classifying events and binning, temporal alignment of data tof_bin=(gate_delay−signal_delay)+raw_bin. The histogrammer classifies the raw data into different types of events using TOF bins calculated from the previous stage. The full or down sampled histogram is also stored in the memory. Further, the histogram data is erased after being read from the memory. The histogram data is also windowed to produce span data. The span data is then processed with statistical filtering and to find the peak search. That is, the signal and noise are differentiated and the region containing the highest estimated signal is determined.

The peak data is then fed to the span histogrammer which reconstructs the highest possible resolution histograms only at the regions containing or including statistical significance. The output data is then in a streaming interface which can be streamed for additional processing in a waveform analyzer, for example. In addition, as shown in 1, the ToF bins can be produced with the FIFO element.

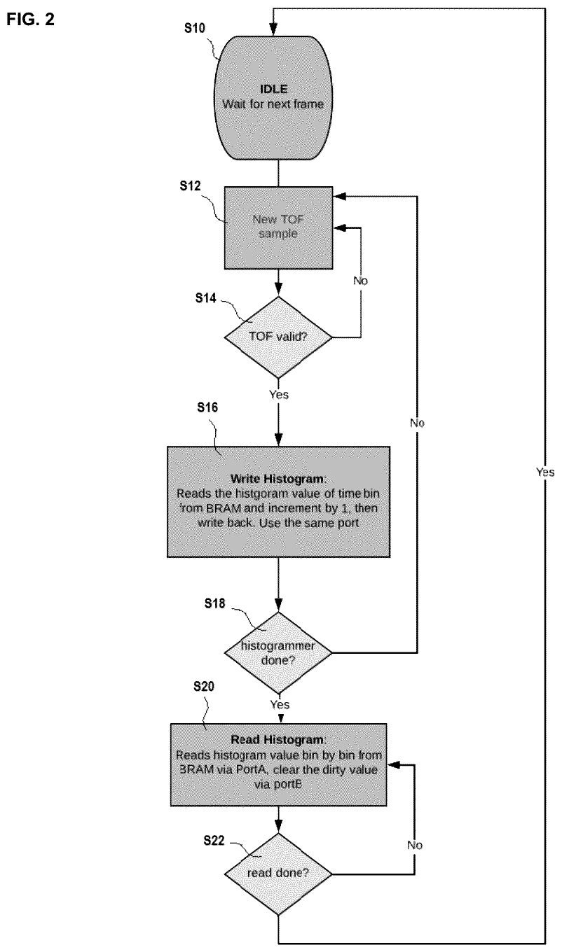

Further, the histogrammer shown in FIG. 1 includes two major phases: a write histogram and a read histogram. That is, in more detail, as shown in FIG. 2, the histogrammer includes an idle period of waiting for a next frame (S10). Then, the method includes viewing a ToF sample data (S12) and determining if the ToF data is valid (S14). When the data is valid (Yes in S14), the histogrammer enters the first major phase corresponding to the write histogram (S16). That is, the histogram value is read from a time bin of a block RAM (BRAM) and incremented by 1, and then written back using the same port. The method in FIG. 2 then includes determining if the histogrammer write phase is completed (S18).

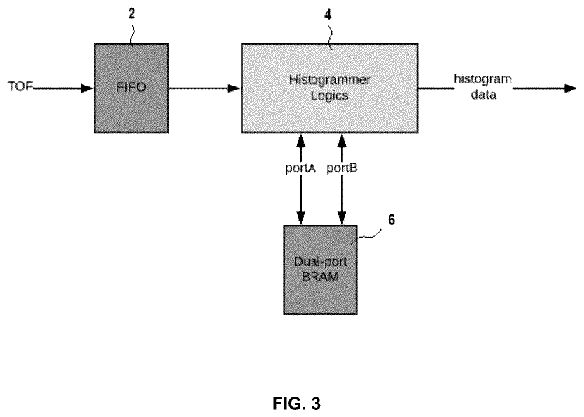

When the write phase is completed (Yes in S18), the next phase (read phase) is entered (S20). That is, the method includes reading the histogram value bin by bin from the BRAM using port A and clearing the read or dirty value using port B (FIG. 3 illustrates dual ports A and B). The method then includes determining if the read phase is completed (S22). If the read phase is not completed, the method returns to step S20.

In more detail, the write histogram shown in step S16 in FIG. 2 is a histogram that is cleared upon reading to prepare a clean slate for the next batch of ToF data, which is a time-domain transformed version of raw GmAPD data. After all the histogram data is read out/cleared, a new group of ToF data can be accepted.

In addition, in the read histogram phase, there can be a 2-clock latency to read data from the BRAM but according to the embodiment of the present disclosure, it is not necessary to wait to read the next value. That is, a clearing process is performed using a different port (e.g., as shown in FIG. 3, a dual port BRAM is used in this embodiment). Therefore, one clock cycle can be advantageously used to read each histogram value.

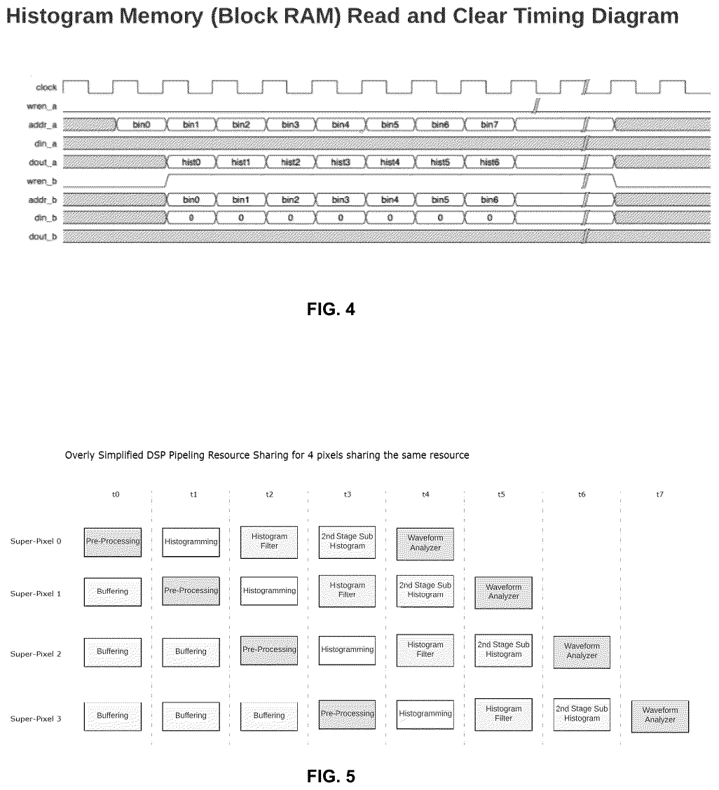

In more detail, FIG. 3 is a block diagram illustrating an operation of a write histogram phase in a device according to an embodiment of the present disclosure. As shown in FIG. 3, the write histogram phase includes a FIFO operation 2 (first in first out) followed by a histogram logic processor including communication with two ports A and B of a dual-port BRAM 6. The processed histogram data is then output. FIG. 4 is a timing diagram illustrating a histogram BRAM read and clear operations.

A histogram filter can also be used to pick out targets from a histogram of avalanche events and a histogram of arming events. In addition, a target returned is a window of histogram bins where the exact range of the target is believed to be inside the span of the window. A waveform analyzer then determines the exact range of the target inside this span.

In addition, FIG. 5 is a diagram illustrating a DSP pipeline resource sharing the same resource according to an embodiment of the present disclosure. That is, FIG. 5 illustrates a simplified DSP pipeline resource sharing for four pixels (0 to 3 pixels) sharing the same resource. As shown, the super-pixels 0 to 3 include a pre-processing step, a histogramming step, a histogram filter step, a second stage sub histogram step and then are streamed to a wavelength analyzer (FIG. 1 illustrates each of these steps). As shown, there is a buffering delay between the pixels,

As described above, a span histogrammer (FIG. 1) is used to identify a sub-histogram of the span where the target location is estimated. Further, the histograms are not saved until after the peaks are found because the BRAM is erased to process the next group of data. In addition, the ToF values that are the output of a pulse decoder are broadcast to both histogrammer 4 and the FIFO 2 so the Span Histogrammer can use it.

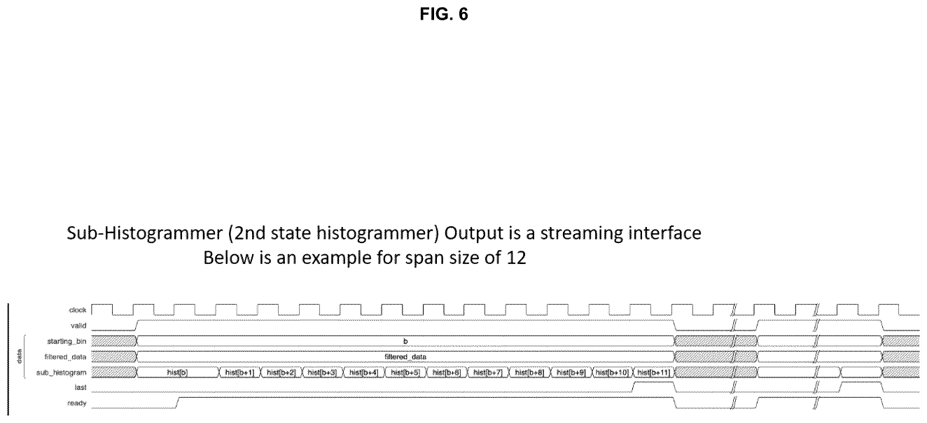

In addition, FIG. 6 is a timing diagram illustrating a sub-histogrammer output for a streaming interface according to an embodiment of the present disclosure (see also FIG. 1). As shown, the sub-histogrammer (2^{nd} state histogrammer) output is a streaming interface. FIG. 6 illustrates an example for a span size of 12.

Further, in rotational imaging devices such as a LIDAR used an autonomous vehicle, it is advantageous that the scene capturing sensors are recording data in their respective direction or pointing angle. The terms LIDAR and rotational imaging device are used interchangeably in this disclosure. In addition, rotational imaging sensors produce large amounts of data which can increase processing time and effort. When onboard a mobile unit such as an AV, the processing resources and power are often limited. Therefore, it is advantageous to segment the field-of-view (“FoV”) of the rotational imaging sensor into at least two regions and allocate processing resources separately between the regions. In particular, the segmentation can be performed at acquisition or can be performed on the data acquired via the sensor, e.g., by dividing the data into multiple groups or swaths according to a position or range at which the acquisition was made.

For example, one of the regions can be a high-priority region or a high relevance region which is to be analyzed more deeply in terms of processing. At least one of the other regions can be a low-priority region where processing is applied relatively sparsely. That is, the low-priority region can be used merely or primarily for data-logging purposes. Conversely, the high-priority regions can be monitored by complimentary backup controllers not monitoring all of the regions. This is advantageous because computational resources are more efficiently utilized.

Further, in a normal operation, the high-priority region in front of the vehicle. However, when segmenting the field-of-view in different priority regions, it is preferable to ensure that the high relevance region is pointing in a meaningful direction. In other words, it is preferable for the high relevance region to have a correct pointing angle.

Ensuring and stabilizing such a pointing angle includes the following methods. For example, the segmenting or grouping of the sensor data can be implemented as a multicast feature. In particular, the multicast feature advantageously allows for a subset of the normally unicast LIDAR data packets (e.g., UDP packets) to be routed to an alternate destination, e.g., a n IP address and UDP port. For example, the LIDAR packets whose azimuth values fall within a multicast azimuth range, defined by a programmable start angle and stop angle, can be routed to a multicast UDP/IP endpoint instead of the unicast UDP/IP endpoint. In addition, the LIDAR packets which are from outside of the azimuth range can, for example, be unicast along with other data such as Geiger-mode Avalanche Photodiode (“GMAPD”) and status packets. As a further example, the different regions can be sector shaped.

As a further example, the segmenting of data can be implemented via a flow control module which creates groups or swaths out of the raw data generated by the device. In more detail, the flow control module can use a reference such as azimuth to form at least two groups of data from the raw data received from the device. The raw data can refer to data from a read-out interface e.g., ROIC, of the imaging device. In addition, the range for a given group or swatch ca be specified by setting limits for the corresponding region defined by two azimuth values specifying a start limit and a stop limit. It is also possible to define just one azimuth value and then specify the number of sensor frames counted from the azimuth value.

Further, it is advantageous when the rotational scanning movement of the LIDAR is synchronized with the masterclock of the system, such as the SDS's precision time protocol (“PTP”) grandmaster. It is also advantageous to synchronize the shutter control of at least one of the cameras of the AV with the masterclock of the system, or to the rotational scanning movement of the LIDAR. For example, it is advantageous for the cameras or sensors to have a global shutter, and the global shutter to be in sync with the LIDAR scanning movement. Thus, the cameras can be controlled such that their shutter is in sync with the LIDAR's rotation.

In more detail, for example, the LIDAR timing or clock can be synchronized to PTP. Similarly, the camera shutter signal may be synchronized to the SDS's PTP. Thus, the images captured via the cameras can be in sync with the LIDAR captured representation, thereby improving the combination of LIDAR data with camera captured images. This combination also leads to an improved synchronization between the LIDAR output stack (e.g., 30 map) and the AV's vision stack (video produced by cameras) resulting in improved detection capabilities of the AV's surrounding environments by the SOS as well as improved compute bandwidth from aligning the two output stacks.

The method according to one embodiment of the present invention also includes an azimuth lock mode in which a camera's and/or LIDAR sensor's pointing angle is controlled relative to time. In the azimuth lock mode, the sensor's view-angle can be azimuthally locked with respect to a fixed reference plane. In other words, an azimuthal phase angle of the sensor is controlled to a predetermined value or range. This control advantageously prevents a positional drift in the pointing angle of sensor (e.g., mechanical optical sensor like a LIDAR). Without this control feature, the sensor's rotation may become free-running and the LIDAR can encounter undesired drifts in the pointing angle. The present disclosure advantageous allows for a more consistent pointing angle for rotational imaging devices.

More specifically, a controller according to an embodiment of the present disclosure controls the LIDAR's rotational speed and/or its angular position such that the camera pointing angle is stabilized to minimize a positional drift in the angle. For example, t h e rotation of the LIDAR can be synchronized with respect to the PTP time. In another example, the azimuthal phase angle can be controlled to be within ±5° during operation. In another example, the azimuthal phase angle can be controlled to be within ±2°.

In addition, a lidar sensor operating on an AV can include a combination of hardware components (e.g., transceiver apparatus including a transmitter assembly and a receiver assembly, processing circuitry, cooling systems, etc.), as well as software components (e.g. software code and algorithms that generate 3D point clouds and signal processing operations that enhance object detection, tracking, and projection).

Various embodiments described herein may be implemented in a computer-readable medium using, for example, software, hardware, or some combination thereof. For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. For a software implementation, the embodiments such as procedures and functions may be implemented together with separate software modules each of which performs at least one of functions and operations. The software code can be implemented with a software application written in any suitable programming language. Also, the software codes may be stored in the memory and executed by the controller.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of controlling a rotational imaging device, the method comprising:
capturing imaging data from a sensor in the imaging device; and
controlling a rotational movement of the rotational imaging device to be synchronized with the capturing of the image data via a same system clock.

2. The method of claim 1, wherein the system clock is a masterclock of the system.

3. The method of claim 2, wherein the masterclock uses a precision time protocol.

4. The method of claim 1, further comprising:
controlling a view angle of the sensor of the rotational imaging device with respect to an azimuthal angle to maintain a predetermined constant azimuthal angle.

5. The method of claim 4, further comprising:
controlling a rotational scan speed of the rotational imaging device to minimize a positional drift in the view angle.

6. The method of claim 4, further comprising:
controlling an angular position of the rotational imaging device to minimize a positional drift in the view angle.

7. The method of claim 1, further comprising:
dividing the imaging data into at least two parts.

8. The method of claim 7, wherein the dividing the imaging date comprises:
grouping the data parts according to an angular position or range of a scan at which the data parts were acquired.
